(19) United States
(12) Patent Application Publication
(10) Pub. No.: US 2025/0335432 A1
(43) Pub. Date: Oct. 30, 2025

(54) DATA QUERY SERVICE TRANSACTION PROCESSING METHOD AND DEVICE BASED ON TUPLE INFORMATION GAIN

(71) Applicant: ZHEJIANG UNIVERSITY, Hangzhou (CN)

(72) Inventors: Xiaoye Miao, Hangzhou (CN); Jianwei Yin, Hangzhou (CN); Huanhuan Peng, Hangzhou (CN)

(21) Appl. No.: 19/090,451

(22) Filed: Mar. 26, 2025

Related U.S. Application Data
(63) Continuation of application No. PCT/CN2024/129247, filed on Nov. 1, 2024.

(30) Foreign Application Priority Data
Apr. 30, 2024 (CN) 202410535931.5

(51) Int. Cl. G06F 16/245; G06F 16/22

(52) U.S. Cl. CPC G06F 16/245; G06F 16/2282

(57) ABSTRACT

The present disclosure provides a data query service transaction processing method based on tuple information gain. The method involves: constructing a support set for each relation in a database according to a data seller's specified information; constructing an auxiliary query according to the support set and a single table query input by a data consumer to obtain the results of both the original and auxiliary queries; calculating information gains of all tuples on a single table and obtaining a query price using an information gain-based pricing function; rewriting an original query and constructing multiple auxiliary queries; extracting and de-duplicating the multiple groups of query results, calculating information gains of all tuples on multiple tables, and obtaining the final query price for transaction according to the pricing function. A data query service transaction processing device, an electronic device, a computer-readable storage medium involving the method are also provided.

### CROSS-REFERENCE TO RELATED APPLICATIONS

This application is a Continuation Application of PCT application PCT/CN2024/129247, filed on Nov. 1, 2024, which claims priority to Chinese patent application No. 202410535931.5 filed on Apr. 30, 2024, entitled “Data query service transaction processing method and device based on tuple information gain”, the entire contents of which are incorporated herein by reference.

### TECHNICAL FIELD

The disclosure relates to the technical field of big data processing, particularly to a data query service transaction processing method and device based on tuple information gain.

### BACKGROUND

With the popularization and development of Internet of Things (IoT) devices, 5G communication technology, and internet technology, data and its applications have generated enormous value. With the increasing demand for interaction, integration, and exchange of big data, big data transactions have emerged. Different organizations and individuals have different data analysis and transaction needs. How to achieve efficient and effective data transactions while meeting various data needs is a major challenge facing the implementation of current data trading platforms. The query-based data transaction model has a wide range of application scenarios, allowing data consumers with limited budgets to express their data needs through queries and purchase the required data, avoiding the high cost of purchasing the entire data set. Due to the variety and complexity of query forms, a simple query pricing transaction process will bring about arbitrage problems.

Arbitrage means that data consumers can infer the result of a high-priced query Q by purchasing multiple low-priced queries Q₁, Q₂, . . . , Qₜ. For example, query Q is to select the age and gender data of users older than 20, that is, Q=“select age, gender from User where age>20”, and the result of query Q can be inferred through queries Q₁=“select age from User where age>20” and Q₂=“select gender from User where age>20”. If the price of query Q is greater than the sum of the prices of Q₁ and Q₂, the data consumer can obtain the result of query Q by purchasing Q₁ and Q₂ at a low price. If arbitrage exists in the query transaction processing process, speculative data consumers will keep trying to obtain the required data at the lowest price, reducing transaction revenue; the existence of arbitrage will also make ordinary data consumers feel unfair and reduce their willingness to trade. Therefore, the data query price function needs to satisfy the arbitrage-free property while ensuring the efficiency of query transaction processing. Existing methods suffer from low computational efficiency and poor interpretability in data query transactions.

### SUMMARY

The objective of the embodiments of the present disclosure is to provide a data query service transaction processing method and device based on tuple information gain to solve the problems of low computational efficiency and poor interpretability in related technologies. According to a first aspect of an embodiment of the present disclosure, a data query service transaction processing method based on tuple information gain is provided, including:
constructing a support set Sᵢ for each relation Rᵢ in a database D according to a size |S| of the support set specified by a data seller, each support set Sᵢ containing a possible value set of tuples in a corresponding relation Rᵢ, each support set Sᵢ being stored in a database server where D is located;
for a query Q on a single table Rᵢ input by a data consumer, replacing a name of the table Rᵢ in the query Q with Sᵢ and obtaining an auxiliary query Q′ on the support set Sᵢ, executing queries Q and Q′ in the database server and obtaining query results O and O′;
calculating an information gain (|Sᵢ|−|Eₜ|) of each tuple t in Rᵢ under Q according to the query results O and O′, accumulating the information gain of all tuples in Rᵢ, and setting a price of the query Q for trading according to an information gain-based pricing function selected by the data seller, where Eₜ represents the possible value set of each tuple t, and (|Sᵢ|−|Eₜ|) represents uncertainties eliminated by t under Q, that is, the information gain of tuple t;
for a query Q on a multi-table R₁, R₂, . . . , Rₖ input by the data consumer, rewriting the query Q to Q′ and building auxiliary queries Q₁, Q₂, . . . , Qₖ on support sets S₁, S₂, . . . , Sₖ based on Q′, and executing the queries Q′, Q₁, Q₂, . . . , Qₖ to obtain query results W, W₁, W₂, . . . , Wₖ; for each relation Rᵢ, extracting data W′ and W′i of the query results W and Wᵢ on Rᵢ, and deduplicating the extracted results to obtain Oᵢ and O′i, i=1, . . . ,k;
calculating an information gain (|Sᵢ|−|Eₜ|) of each tuple t in Rᵢ under Q according to each set of results Oᵢ and O′i, accumulating the information gain of all tuples in Rᵢ, obtaining a price of query Q on Rᵢ according to the information gain-based pricing function selected by the data seller, and obtaining the price of query Q for trading by accumulating the prices on all relationship tables Rᵢ.

According to a second aspect of an embodiment of the present disclosure, a data query service transaction processing device based on tuple information gain is provided, including:
a support set construction module, being used to construct a support set Sᵢ for each relation Rᵢ in a database D according to a size |S| of the support set specified by the data seller, each support set Sᵢ containing a possible value set of the tuples in a corresponding relation Rᵢ, and each support set Sᵢ being stored in a database server where D is located;
a single-table query processing module, being used to replace a name of the table Rᵢ in the single-table query Q input by the data consumer with Sᵢ, obtain an auxiliary query Q′ on the support set Sᵢ, execute the queries Q and Q′ in the database server, and obtain the query results O and O′;
a single-table query transaction module, being used to calculate an information gain (|Sᵢ|−|Eₜ|) of each tuple t in Rᵢ under Q based on the query results O and O′, accumulate the information gain of all tuples in Rᵢ, and set a price of query Q for trading according to an information gain-based pricing function selected by the data seller, where Eₜ represents the possible value set of each tuple t, and (|Sᵢ|−|Eₜ|) represents uncertainties eliminated by t under Q, that is, the information gain of tuple t;
a multi-table query processing module, being used to rewrite a query Q on a multi-tables R₁, R₂, . . . , Rₖ input by the data consumer into Q′, construct auxiliary queries Q₁, Q₂, . . . , Qₖ on the support sets S₁, S₂, . . . , Sₖ according to Q′, execute the queries Q′, Q₁, Q₂, . . . , Qₖ in the database server to obtain query results W, W₁, W₂, . . . , Wₖ, and for each relation Rᵢ, extract data W′ and W′i of the query results W and Wᵢ on Rᵢ and deduplicate the extracted results to obtain Oᵢ and O′i, i=1, . . . , k;
a multi-table query transaction module, being used to calculate an information gain (|Sᵢ|−|Eₜ|) of each tuple t in Rᵢ under Q according to each set of results Oᵢ and O′i, accumulate the information gain of all tuples in Rᵢ, obtain the price of query Q on Rᵢ according to the information gain-based pricing function selected by the data seller, and accumulate the prices on all relationship tables Rᵢ to obtain the price of query Q for trading.

According to a third aspect of an embodiment of the present disclosure, there is provided an electronic device, including:
one or more processors;
a memory for storing one or more programs;
when the one or more programs are executed by the one or more processors, the one or more processors implement the method as described in the first aspect.

According to a fourth aspect of an embodiment of the present disclosure, a computer-readable storage medium is provided, on which computer instructions are stored, and when the instructions are executed by a processor, the steps of the method described in the first aspect are implemented.

Beneficial effects: According to the above technical solutions, the embodiments of the present disclosure provide data sellers with an efficient and arbitrage-free data query transaction processing method. A support set is built for each relation in the database according to the set size specified by the data seller. For single-table queries input by data consumers, an auxiliary query is built. The information gain of all tuples in the corresponding table is calculated based on the original query results and the auxiliary query results, and the query price is published based on the overall information gain and the price function. For multi-table queries input by data consumers, the original query is rewritten, and an auxiliary query is built for each table. The original query results and the auxiliary query results are extracted and deduplicated, and the information gain of all tuples in each table of the multi-table query is then calculated. Finally, the query price is set based on the overall information gain and the price function. This method solves the problems of low processing efficiency and poor interpretability of data query transactions, and supports the practical application of data query transactions.

### BRIEF DESCRIPTION OF DRAWINGS

To more clearly illustrate the technical solutions in the present disclosure or prior art, a brief description of the accompanying drawing to be used in the description of the embodiments or prior art will be given below. The drawing described below is obviously just an embodiment of the present disclosure. For ordinary technicians in this field, other drawings can be obtained based on the drawing without doing creative work.

FIG. 1 is a flow chart of a data query service transaction processing method based on tuple information gain provided by an embodiment of the present disclosure.

FIG. 2 is a diagram showing an example of a database provided by an embodiment of the present disclosure.

FIG. 3 is a diagram showing an example of a support set provided by an embodiment of the present disclosure.

FIG. 4 is a diagram showing an example of a single-table query result provided by an embodiment of the present disclosure.

FIG. 5 is a diagram showing an example of multi-table query results provided by an embodiment of the present disclosure.

FIG. 6 is a diagram showing an example of query processing results provided by an embodiment of the present disclosure.

FIG. 7 is a comparison chart of transaction price and running time in the transaction processing method provided in an embodiment of the present disclosure on the MoveLens movie rating dataset.

FIG. 8 is a block diagram of a data query transaction processing device based on tuple information gain provided by an embodiment of the present disclosure.

### DESCRIPTION OF EMBODIMENTS

The technical solutions in the embodiments of the present disclosure are clearly and completely described below in combination with the specific contents of the present disclosure. Obviously, the described embodiments are only a part of the embodiments of the present disclosure, rather than all the embodiments. Based on the embodiments of the present disclosure, all other embodiments obtained by ordinary technicians in the field without making any creative work shall fall within the protection scope of the present disclosure. The contents not described in detail in the embodiments of the present disclosure belong to the prior art known to professional and technical personnel in the field.

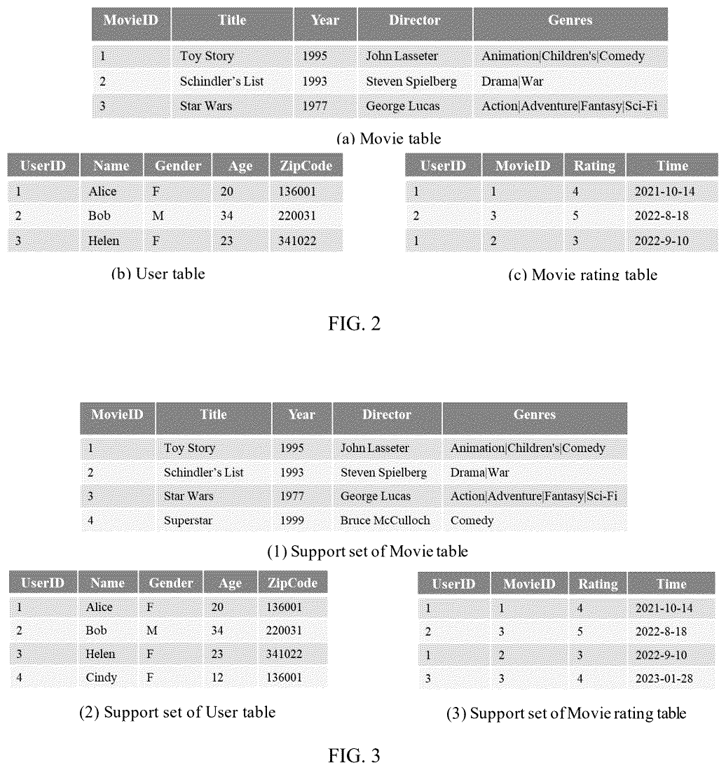

An embodiment of the present disclosure provides a data query service transaction processing method based on tuple information gain, which can be used in a transaction scenario of pricing queries input by data consumers online. In this online data trading market, each data consumer queries the data according to personal needs. For example, a data analyst may be interested in movies (i.e., tuples) produced after 1900 in the movie ratings dataset (as shown in FIG. 2), and query the information of these movies for analysis. The query Q input by the data consumer can be a single-table query, such as the query Q=“select * from movie where year>=1990” on the movie table; it can also be a multi-table query, such as the query Q=“select title, name, rating from movie, user, rating where rating>=4 and rating.userID=user.userID and rating.movieID=movie.movieID” on the movie table and user table, which is used to query the movie name, user and specific rating with a rating greater than or equal to four points. Data query transaction processing requires online transaction pricing for such queries; the method of the present disclosure is described in detail below in conjunction with this scenario.

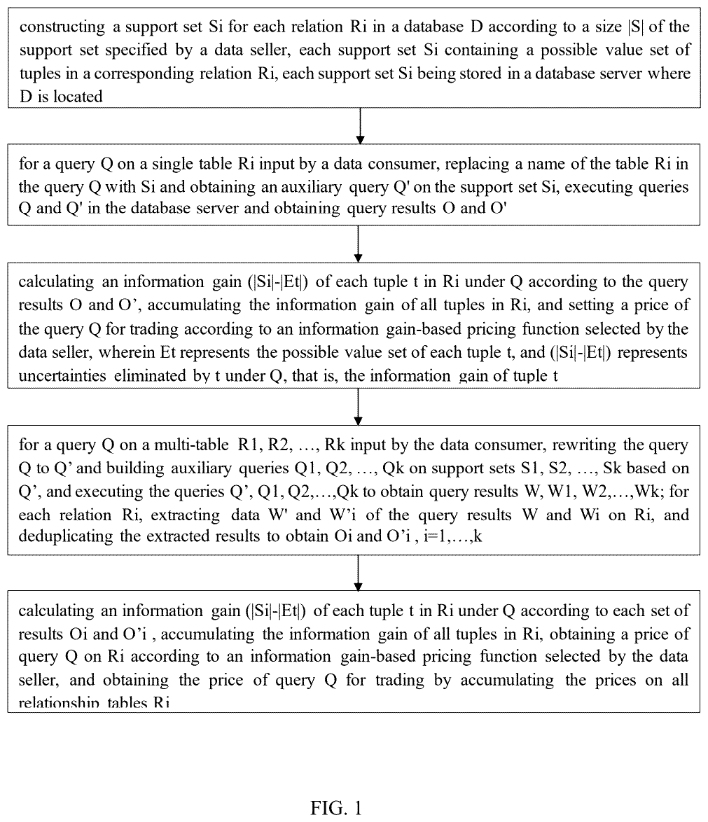

Referring to FIG. 1, the method includes the following steps:

S₁: Constructing a support set Sᵢ for each relation Rᵢ in a database D according to a size |S| of the support set specified by a data seller. Each support set Sᵢ contains a possible value set of tuples in a corresponding relation Rᵢ. Each support set Sᵢ is stored in a database server where D is located.

Specifically, firstly, the size of each support set Sᵢ is calculated according to the total support set size |S|=12 specified by the data seller and the size of each relation Rᵢ in the database |Ri| (i.e. |R₁|=|R₂|=|R₃|=3), i.e.,

$$\vert {S}_{i} \vert = \vert S \vert \cdot \frac{\vert {R}_{i} \vert}{{\sum }_{j = 1}^{m} \vert {R}_{j} \vert} = 4 ,$$

where R₁, R₂, . . . , R₃ are all the movie tables, user tables, and movie rating tables in the movie rating database D.

Then, for each relation Rᵢ (for i=1, 2, 3), let Ti be the number of non-repeating tuples in Rᵢ, then Ti=3. Since |Sᵢ|=4 is greater than Ti, all non-repeating tuples in Rᵢ are added to Sᵢ, and according to the constraint of Rᵢ on the relation, generate 1 non-repeating tuple and add it to Sᵢ. Finally, the support set Sᵢ on each relation Rᵢ is obtained (as shown in FIG. 3), and is stored in the database server where D is located.

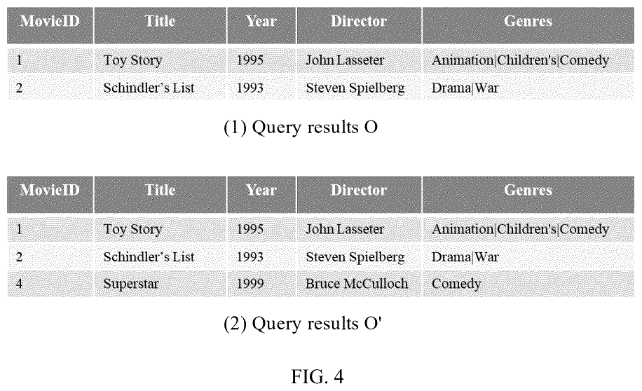

S₂: For the query Q=“select * from movie where year >=1990” on the single table Rᵢ input by the data consumer, replacing the table name Rᵢ in the query Q with Sᵢ, that is, replacing “movie” with “movie_support”, and obtaining an auxiliary query Q′=“select * from movie_support where year >=1990” on the support set Sᵢ. Queries Q and Q′ are executed in the database server to obtain query results O and O′, as shown in FIG. 4.

S₃: Calculating an information gain (|Sᵢ|−|Eₜ|) of each tuple t in Rᵢ under Q based on the query results O and O′, accumulating the information gain of all tuples in Rᵢ, and setting a price of the query Q for trading according to the information gain-based pricing function selected by the data seller, where Eₜ represents the possible value set of each tuple t, and (|Sᵢ|−|Eₜ) represents uncertainties eliminated by t under Q, that is, the information gain of tuple t.

The specific definition of the possible value set Eₜ for each tuple t in the above process includes:
If the result of tuple t under query Q is vₜ and vₜ is not empty, the possible value set Eₜ of t contains the set of elements whose query result is vₜ in Sᵢ, that is, Eₜ={v|v E Sᵢ and Q(v)=vₜ}, and the frequency of occurrence of vₜ can be counted by traversing O′ to obtain |Eₜ| and information gain (|Sᵢ|−|Eₜ|);
If the result of tuple t under query Q is empty, the possible value set Eₜ of t contains the set of elements in Sᵢ that do not satisfy the query condition, that is, Eₜ={v|v E Sᵢ and Q (v)=Ø}, then |Eₜ|=|Sᵢ|−|O| and information gain |Sᵢ|−|Eₜ|=|O|;
According to the above definition, if some single-table queries Q₁, Q₂, . . . , Qₜ can infer query Q, then for each tuple t in Rᵢ, it satisfies where

$${E}_{t}^{1} ∩ {E}_{t}^{2} ∩ … ∩ {E}_{t}^{l} ⊆ {E}_{t}^{Q} ,$$

where

$${E}_{t}^{Q}$$

is the set of possible values of tuple t under Q,

$${E}_{t}^{j}$$

is the set of possible values of tuple query Qᵢ(j=1,2, . . . ,1). This subset relationship ensures pricing is directly based on information gain. The price of each tuple t under Q must be less than or equal to its total price under Q₁, Q₂, . . . , Qₜ, thereby ensuring the no-arbitrage property. At the same time, under this definition, the price of each tuple in the query corresponds to its information gain, which provides an explanatory basis for data query transaction pricing.

Specifically, O′ is traversed to count the occurrence frequency hₒ of each element o, and get the occurrence frequency of each element is 1. The overall information gain of all tuples t in Rᵢ is [symbol] (Rᵢ)=Σ_{t∈R}_{ᵢ}(|Sᵢ|−|Eₜ|)=Σ_{o∈O}(|Sᵢ|−hₒ)+(|Rᵢ|−|O|)·|O′|)=(4−1)+(4−1)+(3−2)·3=9.

Furthermore, data sellers can choose an information gain-based pricing function to convert information gain into query price. The function needs to satisfy monotone increasing and subadditivity in the range of positive integers to ensure the arbitrage-free nature of the query price. Substitute the overall information gain into the information gain-based pricing function selected by the data seller to obtain the price of query Q, and trade at this price.

Specifically, if the information gain-based pricing function selected by the seller is f(x)=log(x+1), then the price of the query Q is log 10.

S₄: For the query Q on multiple tables R₁, R₂, . . . , Rₖ input by the data consumer, rewriting the query Q to Q′, constructig auxiliary queries Q₁, Q₂, . . . , Qₖ on the support sets S₁, S₂, . . . , Sₖ based on Q′, and executing the queries Q′, Q₁, Q₂, . . . , Qₖ to obtain query results W, W₁, W₂, . . . , Wₖ; for each relation Rᵢ (i=1, . . . ,k), extracting a data W′ and W′i of the query results W and Wᵢ on Rᵢ, and deduplicating the results to obtain Oᵢ and O′i.

For all tables R₁, R₂, . . . , Rₖ involved in query Q, primary key attributes of all tables R₁, R₂, . . . , Rₖ are added into the Selection clause of query Q, so as to rewrite query Q into query Q′. Based on Q′, for each table Rᵢ (i=1, 2, . . . , k) involved in query Q, the table name Rᵢ in Q′ is replaced with Sᵢ to obtain auxiliary query Qᵢ (i=1, 2, . . . , k). Queries Q′, Q₁, Q₂, . . . , Qₖ are executed in the database server to obtain query results W, W₁, W₂, . . . , Wₖ.

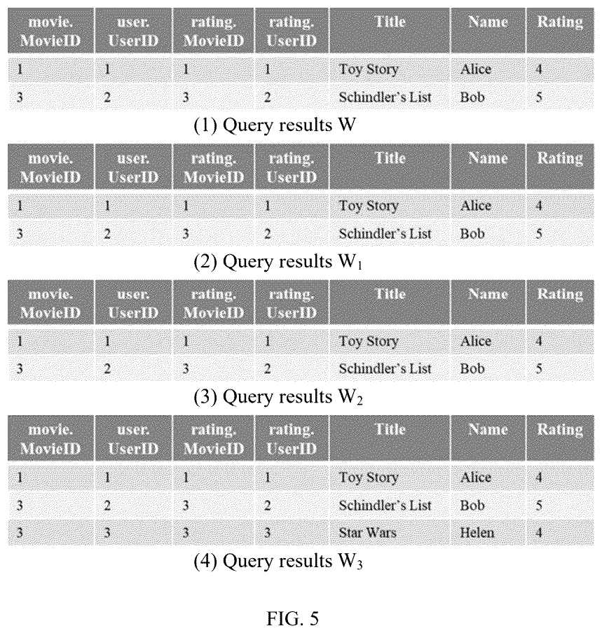

Specifically, if the query Q is Q=“select title, name, rating from movie, user, rating where rating >=4 and rating.userID=user.userID and rating.movieID=movie.movieID”, by adding the primary key attributes on all tables (i.e., movieID and userID) in the Selection clause of the query Q, the query Q is rewritten as query Q′=“select movie.movieID, user.userID, rating.movieID, rating.userID, title, name, rating from movie, user, rating where rating >=4 and rating.userID=user.userID and rating.movieID=movie.movieID”. Further, by replacing the table name, three auxiliary queries are obtained: Q₁=“select movie_support.movieID, user.userID, rating.movieID, rating.userID, title, name, rating from movie_support, user, rating where rating >=4 and rating.userID=user.userID and rating.movieID=movie_support.movieID”, Q₂=“select movie.movieID, user_support.userID, rating.movieID, rating.userID, title, name, rating from movie, user_support, rating where rating >=4 and rating.userID=user_support.userID and rating.movieID=movie.movieID”, Q₃=“select movie.movieID, user.userID, rating_support.movieID, rating_support.userID, title, name, rating from movie, user, rating_support where rating >=4 and rating_support.userID=user.userID and rating_support.movieID=movie.movieID”. The results W, W₁, W₂, and W₃ of query Q′, Q₁, Q₂, and Q₃ are shown in FIG. 5.

Since the query Q′ (or Qᵢ) specifies the query filter conditions and the columns to be output, the query result W (or Wᵢ) includes multiple rows and columns of data. Checking each column in W (or Wᵢ) in turn, if the column belongs to the relation Rᵢ, the column is then retained; otherwise, the column is removed to obtain the result W′ (or W′i) of W (or Wᵢ) in Rᵢ.

Since query Q′ (or Qᵢ) is a multi-table query, the extracted query result W′ (or W′i) may contain duplicate data. Each row in W′ (or W′i) is checked in turn to remove duplicate query results. The primary key column is added during the query rewriting process and is deleted to obtain Oᵢ (or O′i).

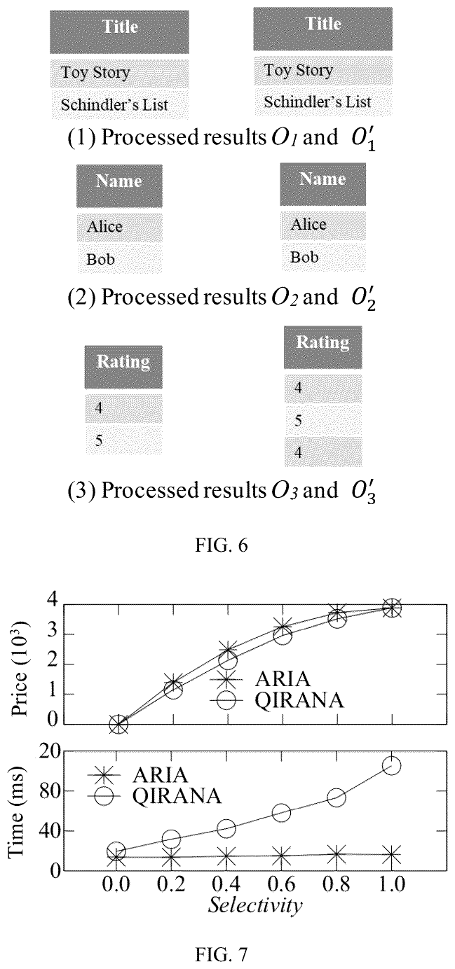

Specifically, for i=1, 2, 3, each set of query results W and Wᵢ are screened, deduplicated, and the primary key columns are deleted to obtain the processed results Oᵢ and O′i as shown in FIG. 6. For example, for i=1 (ie, the movie table), the movie.movieID and title columns on W and Wᵢ are retained, and the remaining columns are deleted; then duplicate elements are deleted, and the primary key column movie.movieID is deleted, resulting in O1 and O′1 in FIG. 6.

S5: Calculating the information gain (|Sᵢ|−|Eₜ|) of each tuple t in Rᵢ under Q according to each set of results Oᵢ and O′i, accumulating the information gain of all tuples in Rᵢ, obtaining a price of query Q on Rᵢ according to the information gain-based pricing function selected by the data seller, and obtaining the price of query Q for trading by accumulating the prices on all relationship tables Rᵢ (i=1, . . . ,k).

O′ᵢ is traversed to count the occurrence frequency hₒ of each element o. The overall information gain of all tuples t in Rᵢ is

$$𝒥 ( {R}_{i} ) = {\sum }_{t ∈ {R}_{i}} ( \vert {S}_{i} \vert - \vert {E}_{t} \vert ) = {\sum }_{o ∈ {O}_{i}} ( \vert {S}_{i} \vert - {h}_{o} ) + ( \vert {R}_{i} \vert - \vert {O}_{i} \vert ) \cdot \vert {O}_{i}^{′} \vert .$$

The overall information gain on Rᵢ is substituted into the information gain-based pricing function selected by the data seller to obtain the price of query Q on Ri. The prices on all relationship tables R₁, R₂, . . . , Rₖ are accumulated to obtain the final price of query Q and trade.

Specifically, by traversing O′1, O′2, and O′3, the information gains of the three tables R₁, R₂, and R₃ are [symbol] (R₁)=(4−1)+(4−1)+(3−2)·2=8, [symbol] (R₂)=(4−1)+(4−1)+(3−2)·2=8, and [symbol] (R₃)=(4−2)+(4−1)+(3−2)·3=8, respectively. Given the information gain-based pricing function f (x)=log (x+1), it can be obtained that the prices of Q in the three tables are all log 9, and the total price is 3.log 9.

### EMBODIMENT

The transaction processing method of the present disclosure is implemented on an Ubuntu 18.04 system running on an Intel core 2.80 GHz server with 192 GB of memory, and the performance of query transaction processing of the embodiment of the present disclosure on the MovieLens dataset is tested under different Selectivities (i.e., the ratio of the query result set size to the data table size).

The performance effect of the data query transaction processing method (i.e, ARIA) proposed in the present disclosure is tested and analyzed through simulation experiments, and the results are shown in FIG. 7. It can be seen that ARIA is more efficient than the existing processing method based on database information gain (i.e., QIRANA method). The query price set by the ARIA method is higher because it considers more fine-grained information gain and is more comprehensive.

Corresponding to the aforementioned embodiment of the data query service transaction processing method based on tuple information gain, the present disclosure also provides an embodiment of a data query service transaction processing device based on tuple information gain.

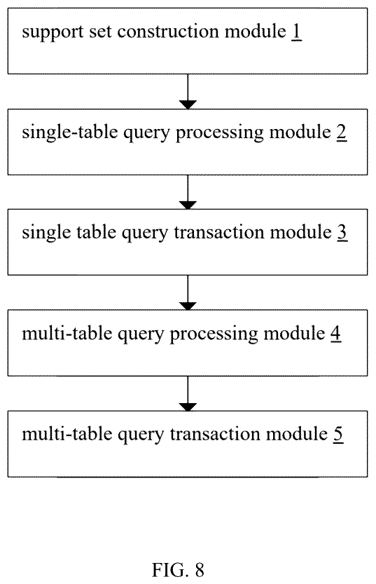

Referring to FIG. 8, the data query service transaction processing device based on tuple information gain includes:

A support set construction module 1 that is used to construct a support set Sᵢ for each relation Rᵢ in database D according to the support set size |S| specified by the data seller. Each support set Sᵢ contains a possible value set of tuples in the corresponding relation Rᵢ, and each support set Sᵢ is stored in the database server where D is located.

A single-table query processing module 2 that is used to replace the table name Rᵢ in the single-table query Q input by the data consumer with Sᵢ, obtain the auxiliary query Q′ on the support set Sᵢ, execute the queries Q and Q′ in the database server, and obtain the query results O and O′.

A single table query transaction module 3 that is used to calculate the information gain (|Sᵢ|−|Eₜ|) of each tuple t in Rᵢ under Q according to the query results O and O′, accumulate the information gain of all tuples in Rᵢ, and set the price of query Q for transaction according to the information gain-based pricing function selected by the data seller, where Eₜ represents the possible value set of each tuple t, (|Sᵢ|−|Eₜ|) represents uncertainties eliminated by t under Q, that is, the information gain of tuple t.

A multi-table query processing module 4 that is used to rewrite the query Q on the multi-tables R₁, R₂, . . . , Rₖ input by the data consumer into Q′, construct auxiliary queries Q₁, Q₂, . . . , Qₖ on the support sets S₁, S₂, . . . , Sₖ according to Q′, execute the queries Q′, Q₂, Qₖ, . . . , Q₁ in the database server to obtain query results W, W₁, W₂, . . . , Wₖ, and for each relation Rᵢ (i=1, . . . , k), extract the data W′ and W′i of the query results W and Wᵢ on Rᵢ and deduplicate the results to obtain Oᵢ and O′i.

A multi-table query transaction module 5 that is used to calculate the information gain ((Sᵢ|−|Eₜ|) of each tuple t in Rᵢ under Q according to each set of results Oᵢ and O′i, accumulate the information gain of all tuples in Rᵢ, obtain the price of query Q on Rᵢ according to the information gain-based pricing function selected by the data seller, and accumulate the prices on all relationship tables Rᵢ (i=1, . . . ,k) to obtain the price of query Q for trading.

With respect to the device in the above embodiment, the specific manner in which each module performs has been described in detail in the embodiments relating to the method, and will not be described in detail herein.

As for the device embodiment, since it basically corresponds to the method embodiment, the relevant parts may be referred to the partial description of the method embodiment and will not be described here in detail.

For the device embodiment, since it corresponds essentially to the method embodiment, it is sufficient to refer to a portion of the description of the method embodiment where relevant. The above-described device embodiments are merely schematic, wherein the units described as illustrated as separated components may or may not be physically separated, and the components shown as units may or may not be physical units, i.e., they may be in one place or may also be distributed to a plurality of network units. Some or all these modules can be selected to fulfill the purpose of the present application program according to actual needs. It can be understood and implemented by a person of ordinary skill in the art without creative labor.

Correspondingly, the present disclosure also provides an electronic device including: one or more processors; a memory for storing one or more programs; when the one or more programs are executed by the one or more processors, the one or more processors implement the data query transaction processing method based on tuple information gain as described above.

Correspondingly, the present disclosure also provides a computer-readable storage medium on which computer instructions are stored. When the instructions are executed by a processor, the data query transaction processing method based on tuple information gain as described above is implemented.

It should be noted that the present disclosure is not limited to the exact technical solutions that has been described above and shown in the drawings, and that various modifications and changes may be made without departing from the scope thereof.

What is claimed is:

1. A data query service transaction processing method based on tuple information gain, comprising steps of:
constructing a support set Sᵢ for each relation Rᵢ in a database D according to a size |S| of the support set specified by a data seller, each support set Sᵢ containing a possible value set of tuples in a corresponding relation Rᵢ, each support set Sᵢ being stored in a database server where D is located;
for a query Q on a single table Rᵢ input by a data consumer, replacing a name of the table Rᵢ in the query Q with Sᵢ and obtaining an auxiliary query Q′ on the support set Sᵢ, executing queries Q and Q′ in the database server and obtaining query results O and O′;
calculating an information gain (|Sᵢ|−|Eₜ|) of each tuple t in Rᵢ under Q according to the query results O and O′, accumulating the information gain of all tuples in Rᵢ, and setting a price of the query Q for trading according to an information gain-based pricing function selected by the data seller, where Eₜ represents the possible value set of each tuple t, and (|Sᵢ|−[Eₜ]) represents uncertainties eliminated by t under Q, that is, the information gain of tuple t;
for a query Q on a multi-table R₁, R₂, . . . , Rₖ input by the data consumer, rewriting the query Q to Q′ and building auxiliary queries Q₁, Q₂, . . . , Qₖ on support sets S₁, S₂, . . . , Sₖ based on Q′, and executing the queries Q′, Q₁, Q₂, . . . , Qₖ to obtain query results W, W₁, W₂, . . . , Wₖ; for each relation Rᵢ, extracting data W′ and W′ᵢ of the query results W and Wᵢ on Rᵢ, and deduplicating the extracted results to obtain Oᵢ and O′ᵢ, i=1, . . . ,k; and
calculating an information gain (|Sᵢ|−|Eₜ|) of each tuple t in Rᵢ under Q according to each set of results Oᵢ and O′ᵢ, accumulating the information gain of all tuples in Rᵢ, obtaining a price of query Q on Rᵢ according to the information gain-based pricing function selected by the data seller, and obtaining the price of query Q for trading by accumulating the prices on all relationship tables Rᵢ.

2. The method according to claim 1, wherein the support set Sᵢ on each relationship table Rᵢ is constructed as follows:
firstly, calculating a size of each support set Sᵢ according to the total support set size |S| specified by the data seller and the size of each relation Rᵢ in the database |Rᵢ|, which is
$$\vert {S}_{i} \vert = \vert S \vert \cdot \frac{\vert {R}_{i} \vert}{{\sum }_{j = 1}^{m} \vert {R}_{j} \vert} ,$$
wherein R₁, R₂, . . . , Rₘ are all the relations in the database D;
secondly, for each relation Rᵢ, the corresponding support set Sᵢ is constructed as follows: letting Ti be the number of non-repeating tuples in Rᵢ; if |Sᵢ| is less than or equal to Ti, randomly selecting |Sᵢ| non-repeating tuples from Rᵢ and adding them to Sᵢ; if |Sᵢ| is greater than Ti, adding all non-repeating tuples in Rᵢ to Sᵢ, and generating (|Sᵢ|−Ti) non-repeating tuples and adding them to Sᵢ according to the constraints of the relation Rᵢ.

3. The method according to claim 1, wherein the step of calculating the information gain (|Sᵢ|−|Eₜ|) of each tuple t in Rᵢ under Q according to the result sets Oᵢ and O′ᵢ comprises:
traversing O′ to count the frequency of occurrence of vₜ and obtain |Eₜ| and information gain (|Sᵢ|−|Eₜ|) if the result of tuple t under query Q is vₜ and vₜ is not empty, where the possible value set Eₜ of t contains the set of elements whose query result is vₜ in Sᵢ, i.e., Eₜ={v|v E Sᵢ and Q(v)=vₜ};
computing |Eₜ|=|Sᵢ|−|O| and information gain |Sᵢ|−|Eₜ|=|O| if the result of tuple t under query Q is empty, where the possible value set Eₜ of t contains the set of elements in Sᵢ that do not satisfy the query condition, that is, Eₜ={v|v∈Sᵢ and Q(v)=Ø};
traversing O′ to count the occurrence frequency hₒ of each element o, calculating the overall information gain of all tuples t in Rᵢ as [symbol] (Rᵢ)=Σ_{t∈R}_{ᵢ}; (|Sᵢ|−Eₜ|)=Σ_{o∈O}(|Sᵢ|−hₒ)+(|Rᵢ|−|O|)·|O′|, substituting the overall information gain into the information gain-based pricing function selected by the data seller to obtain the price of query Q, and trading Q at this price.

4. The method according to claim 1, wherein the query rewriting and auxiliary query generation on the multiple tables R₁, R₂, . . . , Rₖ are as follows:
for all tables R₁, R₂, . . . , Rₖ involved in the query Q, adding primary key attributes of all tables R₁, R₂, . . . , Rx into the Selection clause of query Q to rewrite the query Q into the query Q′;
based on Q′, for each table Rᵢ (i=1, 2, . . . , k) involved in the query Q, replacing the table name Rᵢ in Q′ with Sᵢ to obtain the auxiliary query Qᵢ, i=1, 2, . . . , k.

5. The method according to claim 1, wherein the query result extraction process is as follows:
checking each column in W or Wᵢ in turn since that the query Q′ or Qᵢ is the multi-table query, and that the query result W or Wᵢ includes multiple rows and columns of data;
retaining a column of data if the column belongs to the relation Rᵢ; otherwise removing the column to obtain the result W′ or W′ᵢ of W or Wᵢ on Rᵢ.

6. The method according to claim 1, wherein the query result deduplication process comprises:
based on the situation that the query Q′ or Qᵢ is a multi-table query, and that the extracted query result W′ or W′ᵢ may contain duplicate data, checking each row in W′ or W′ᵢ in turn to remove duplicate query results, and deleting a primary key column added during the query rewriting process to obtain Oᵢ or O′ᵢ.

7. The method according to claim 1, further comprising:
traversing O′ᵢ to count the occurrence frequency hₒ of each element o, calculating the overall information gain of all tuples t in Rᵢ as
$$𝒥 ( {R}_{i} ) = {\sum }_{t ∈ {R}_{i}} ( \vert {S}_{i} \vert - \vert {E}_{t} \vert ) = {\sum }_{o ∈ {O}_{i}} ( \vert {S}_{i} \vert - {h}_{o} ) + ( \vert {R}_{i} \vert - \vert {O}_{i} \vert ) \cdot \vert {O}_{i}^{′} \vert ,$$
substituting the overall information gain on Rᵢ into the information gain-based pricing function selected by the data seller to obtain the price of the query Q on Rᵢ, accumulating the prices on all relationship tables R₁, R₂, . . . , Rₖ to obtain the final price of the query Q and trade Q at this price.

8. A data query service transaction processing device based on tuple information gain, comprising:
a support set construction module, being used to construct a support set Sᵢ for each relation Rᵢ in a database D according to a size |S| of the support set specified by the data seller, each support set Sᵢ containing a possible value set of the tuples in a corresponding relation Rᵢ, and each support set Sᵢ being stored in a database server where D is located;
a single-table query processing module, being used to replace a name of the table Rᵢ in the single-table query Q input by the data consumer with Sᵢ, obtain an auxiliary query Q′ on the support set Sᵢ, execute the queries Q and Q′ in the database server, and obtain the query results O and O′;
a single-table query transaction module, being used to calculate an information gain (|Sᵢ|−|Eₜ|) of each tuple t in Rᵢ under Q based on the query results O and O′, accumulate the information gain of all tuples in Rᵢ, and set a price of query Q for trading according to an information gain-based pricing function selected by the data seller, wherein Eₜ represents the possible value set of each tuple t, and (|Sᵢ|−|Eₜ|) represents uncertainties eliminated by t under Q, that is, the information gain of tuple t;
a multi-table query processing module, being used to rewrite a query Q on a multi-tables R₁, R₂, . . . , Rₖ input by the data consumer into Q′, construct auxiliary queries Q₁, Q₂, . . . , Qₖ on the support sets S₁, S₂, . . . , Sₖ according to Q′, execute the queries Q′, Q₁, Q₂, . . . , Qₖ in the database server to obtain query results W, W₁, W₂, . . . , Wₖ, and for each relation Rᵢ, extract data W′ and W′ᵢ of the query results W and Wᵢ on Rᵢ and deduplicate the extracted results to obtain Oᵢ and O′ᵢ, i=1, . . . , k; and
a multi-table query transaction module, being used to calculate an information gain (|Sᵢ|−|Eₜ|) of each tuple t in Rᵢ under Q according to each set of results Oᵢ and O′ᵢ, accumulate the information gain of all tuples in Rᵢ, obtain the price of query Q on Rᵢ according to the information gain-based pricing function selected by the data seller, and accumulate the prices on all relationship tables Rᵢ to obtain the price of query Q for trading.

9. The data query service transaction processing device according to claim 8, wherein the support set construction module is further used to:
calculate a size of each support set Sᵢ according to the total support set size |S| specified by the data seller and the size of each relation Rᵢ in the database |Rᵢ|, which is
$$\vert {S}_{i} \vert = \vert S \vert \cdot \frac{\vert {R}_{i} \vert}{{\sum }_{j = 1}^{m} \vert {R}_{j} \vert} ,$$
wherein R₁, R₂, . . . , Rₘ are all the relations in the database D;
let Ti be the number of non-repeating tuples in Rᵢ; if |Sᵢ| is less than or equal to Ti, randomly select |Sᵢ| non-repeating tuples from Rᵢ and add them to Sᵢ; if |Sᵢ| is greater than Ti, add all non-repeating tuples in Rᵢ to Sᵢ, and generate (|Sᵢ|−Ti) non-repeating tuples and add them to Sᵢ according to the constraints of Rᵢ on the relation.

10. The data query service transaction processing device according to claim 8, wherein the single-table query transaction module is further used to:
traverse O′ to count the frequency of occurrence of vₜ and obtain |Eₜ| and information gain (|Sᵢ|−|Eₜ|) if the result of tuple t under query Q is vₜ and vₜ is not empty, where the possible value set Eₜ of t contains the set of elements whose query result is vₜ in Sᵢ, i.e., Eₜ={v|v∈Sᵢ and Q (v)=vₜ};
computing |Eₜ|=|Sᵢ|−|O| and information gain |Sᵢ|−|Eₜ|=|O| if the result of tuple t under query Q is empty, where the possible value set Eₜ of t contains the set of elements in Sᵢ that do not satisfy the query condition, that is, Eₜ={v|v E Sᵢ and Q(v)=Ø};
traverse O′ to count the occurrence frequency hₒ of each element o, calculate the overall information gain of all tuples t in Rᵢ as [symbol] (Rᵢ)=Σ_{tER}_{ᵢ}(|Sᵢ|−|Eₜ|)=Σ_{o∈O}(|Sᵢ|−hₒ)+(|Rᵢ|−|O|)·|O′|, substitute the overall information gain into the information gain-based pricing function selected by the data seller to obtain the price of query Q, and trade Q at this price.

11. The data query service transaction processing device according to claim 8, wherein the multi-table query processing module is further used to:
for all tables R₁, R₂, . . . , Rₖ involved in the query Q, add primary key attributes of all tables R₁, R₂, . . . , Rₖ into the Selection clause of query Q to rewrite the query Q into the query Q′;
based on Q′, for each table Rᵢ (i=1, 2, . . . , k) involved in the query Q, replace the table name Rᵢ in Q′ with Sᵢ to obtain the auxiliary query Qᵢ, i=1, 2, . . . , k.

12. The data query service transaction processing device according to claim 8, wherein the multi-table query processing module is further used to:
check each column in W or Wᵢ in turn since that the query Q′ or Qᵢ is the multi-table query, and that the query result W or Wᵢ includes multiple rows and columns of data;
retain a column of data if the column belongs to the relation Rᵢ; otherwise remove the column to obtain the result W′ or W′ᵢ of W or Wᵢ on Rᵢ.

13. The data query service transaction processing device according to claim 8, wherein the multi-table query processing module is further used to:
based on the situation that the query Q′ or Qᵢ is a multi-table query, and that the extracted query result W′ or W′ᵢ may contain duplicate data, check each row in W′ or W′ᵢ in turn to remove duplicate query results, and delete a primary key column added during the query rewriting process to obtain Oᵢ or O′ᵢ.

14. The data query service transaction processing device according to claim 8, wherein the multi-table query transaction module is further used to:
traverse O′ᵢ to count the occurrence frequency hₒ of each element o, calculate the overall information gain of all tuples t in Rᵢ as
$$𝒥 ( {R}_{i} ) = {\sum }_{t ∈ {R}_{i}} ( \vert {S}_{i} \vert - \vert {E}_{t} \vert ) = {\sum }_{o ∈ {O}_{i}} ( \vert {S}_{i} \vert - {h}_{o} ) + ( \vert {R}_{i} \vert - \vert {O}_{i} \vert ) \cdot \vert {O}_{i}^{′} \vert ,$$
substitute the overall information gain on Rᵢ into the information gain-based pricing function selected by the data seller to obtain the price of the query Q on Rᵢ, accumulate the prices on all relationship tables R₁, R₂, . . . , Rₖ to obtain the final price of the query Q and trade Q at this price.

15. An electronic device, comprising:
one or more processors;
a memory for storing one or more programs;
when the one or more programs are executed by the one or more processors, the one or more processors implement the method according to claim 1.

16. A computer-readable storage medium having a computer program stored thereon, wherein when the program is executed by a processor, the method according to claim 1 is implemented.
